(19) United States
(12) Patent Application Publication
(10) Pub. No.: US 2009/0212059 A1
(43) Pub. Date: Aug. 27, 2009

(54) INSULATED WATER BOTTLE ASSEMBLY

(76) Inventor: Ming-Chang Chen, Tainan Hsien (TW)

Correspondence Address: OSTROLENK FABER GERB & SOFFEN, 1180 AVENUE OF THE AMERICAS, NEW YORK, NY, 100368403, US

(21) Appl. No.: 12/037,969

(22) Filed: Feb. 27, 2008

(51) Int. Cl. A47J 41/00

(52) U.S. Cl. 220/592.17; 220/592.2; 215/12.1

(57) ABSTRACT

An insulated water bottle assembly includes an inner shell, an outer shell, and an insulation unit. The inner shell has an inner wall defining a liquid-holding space and an outer wall opposite to the inner wall. The outer shell has inner and outer surfaces. The outer shell is sleeved over the inner shell and cooperates with the inner shell to define a sealed insulation compartment therebetween. The insulation unit is disposed in the insulation compartment, and includes a first reflective layer formed on the outer wall of the inner shell, an insulative layer surrounding the first reflective layer, and a second reflective layer interposed between the inner surface of the outer shell and the insulative layer.

### BACKGROUND OF THE INVENTION

1. Field of the Invention

The invention relates to a water bottle, more particularly to an insulated water bottle assembly.

2. Description of the Related Art

Water bottles are normally provided with a single-layer structure that is fabricated either using a metal material (e.g., stainless steel) or a plastic material. Although such water bottles are effective in their portability and functionality, they cannot preserve the temperature of their contents for a long time. In other words, the hot and cold liquids stored in conventional water bottles are influenced by the ambient temperature.

### SUMMARY OF THE INVENTION

It is an object of the present invention to provide an insulated water bottle assembly that can overcome the above drawback of the prior art.

According to the present invention, an insulated water bottle assembly includes an inner shell, an outer shell, and an insulation unit. The inner shell has an inner wall defining a liquid-holding space and an outer wall opposite to the inner wall. The outer shell has inner and outer surfaces. The outer shell is sleeved over the inner shell and cooperates with the inner shell to define a sealed insulation compartment therebetween. The insulation unit is disposed in the insulation compartment, and includes a first reflective layer formed on the outer wall of the inner shell, an insulative layer surrounding the first reflective layer, and a second reflective layer interposed between the inner surface of the outer shell and the insulative layer.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an insulated water bottle assembly according to the present invention;

FIG. 2 is an exploded perspective view of the insulated water bottle assembly shown in FIG. 1; and

FIG. 3 is a partly sectional view of the preferred embodiment.

### DETAILED DESCRIPTION OF THE PREFERRED EMBODIMENT

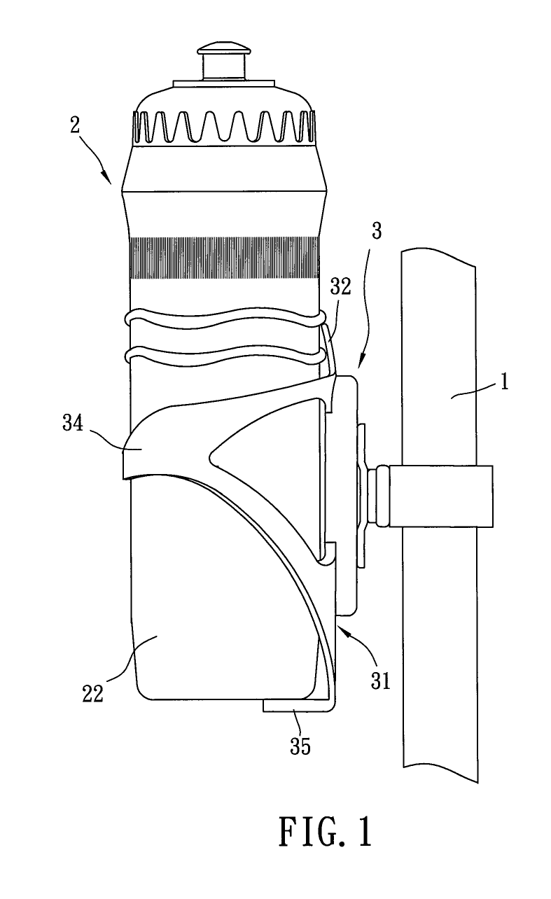

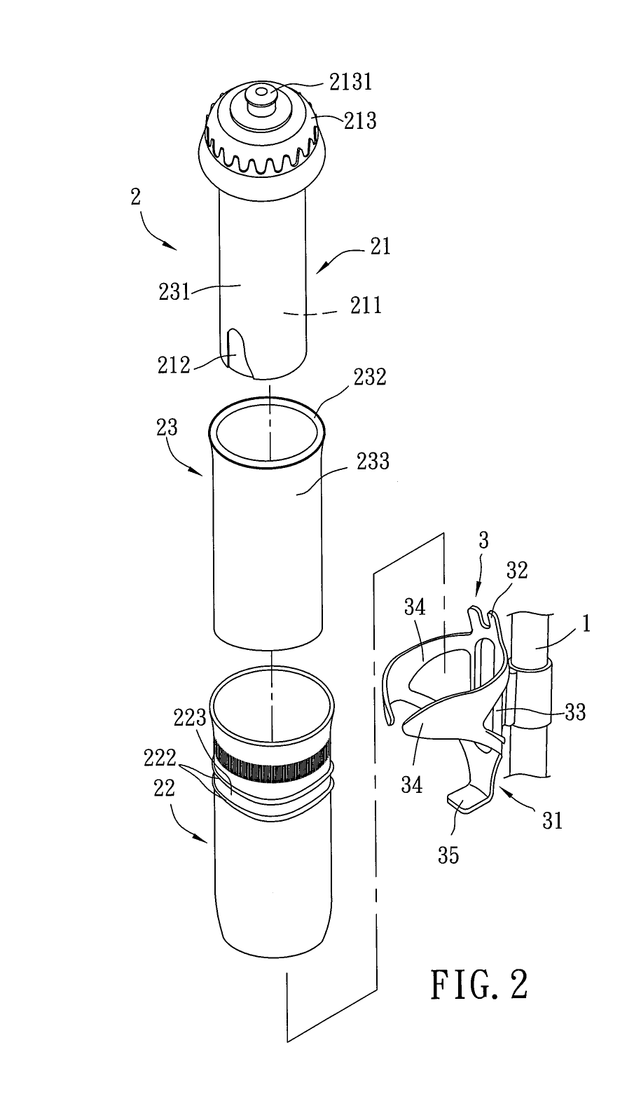

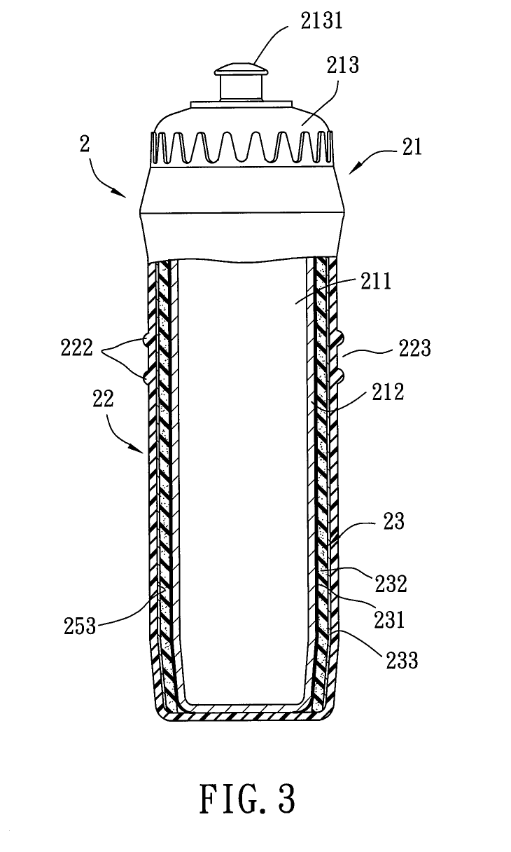

Referring to FIGS. 1 to 3, the preferred embodiment of an insulated water bottle assembly 2 according to the present invention can be used as a sports water bottle. The insulated water bottle assembly 2 includes an inner shell 21, an outer shell 22, and an insulation unit 23. In the preferred embodiment, the inner and outer shells 21, 22 are formed in a cylindrical shape, and the outer shell 22 is made of a plastic material. The inner shell 21 has an inner wall defining a liquid-holding space 211 and an outer wall opposite to the inner wall. The outer shell 22 has inner and outer surfaces. The outer shell 22 is sleeved over the inner shell 21 and cooperates with the inner shell 21 to define a sealed insulation compartment 253 therebetween. The insulation unit 23 is disposed in the insulation compartment 253, and includes a first reflective layer 231 formed on the outer wall of the inner shell 21, an insulative layer 232 surrounding the first reflective layer 231, and a second reflective layer 233 interposed between the inner surface of the outer shell 22 and the insulative layer 232. The outer shell 22 includes a pair of spaced-apart ridges 222 protruding from the outer surface thereof to define a gap 223 therebetween. In the preferred embodiment, the insulated water bottle assembly 2 further includes a holder 3 that is adapted to be disposed on a vehicle 1, such as a bicycle. The holder 3 includes a support 31 for supportably receiving the outer shell 22, and a catch member 32 extending from the support 31. The support 31 includes a backboard 33, a surrounding ring 34 extending from the backboard 33 for holding the outer shell 22, and a base 35 extending substantially perpendicularly from the backboard 33 for supporting a bottom portion of the outer surface of the outer shell 22. The catch member 32 engages the gap 223 between the ridges 222 and loosely contacts the outer surface of the outer shell 22. This can reinforce the assembly between the outer shell 22 and the holder 3 while, at the same time, not adversely affecting the ability of the outer shell 22 to be removed readily from the holder 3.

The first reflective layer 231 of the insulation unit 23 is made from one of a silver film and a copper film, and in the preferred embodiment, a silver film is used. The second reflective layer 233 of the insulation unit 23 is made from one of a copper film and an aluminum film, and in the preferred embodiment, an aluminum film is used. The insulative layer 232 of the insulation unit 23 is fabricated from a sponge-like material in the preferred embodiment.

The inner shell 21 includes a container portion 212 defining the liquid-holding space 211 and that has a top end, and a lid 213 removably threaded to the top end of the container portion 212. The lid 213 of the inner shell 21 includes a spigot 2131 that is operable to selectively communicate the liquid-holding space 211 with the outside environment when the lid 213 is threaded to the top end of the container portion 212. Since the constructions of the lid 213 and the spigot 2131 are known to those skilled in the art and are not the primary feature of the present invention, a detailed description of the same will be dispensed with herein for the sake of brevity.

The inner and outer shells 21, 22 form a double-layer structure. Additionally, the first and second reflective layers 231, 233 minimize radiative heat loss. Finally, the low thermal conductivity of the insulative layer 232 avoids heat transfer by conduction or convection. As such, when the liquid-holding space 211 is filled with a hot or cold liquid, the temperature of the liquid is maintained for a long period of time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An insulated water bottle assembly comprising:
an inner shell having an inner wall defining a liquid-holding space and an outer wall opposite to said inner wall;
an outer shell having inner and outer surfaces, said outer shell being sleeved over said inner shell and cooperating with said inner shell to define a sealed insulation compartment therebetween; and
an insulation unit disposed in said insulation compartment, and including a first reflective layer formed on said outer wall of said inner shell, an insulative layer surrounding said first reflective layer, and a second reflective layer interposed between said inner surface of said outer shell and said insulative layer.

2. The insulated water bottle assembly of claim 1, further comprising a holder adapted to be disposed on a vehicle and including a support for supportably receiving said outer shell, and a catch member extending from said support,
wherein said outer shell includes a pair of ridges protruding from said outer surface thereof to define a gap therebetween, said catch member engaging said gap between said ridges.

3. The insulated water bottle assembly of claim 2, wherein said first reflective layer of said insulation unit is made from one of a silver film and a copper film.

4. The insulated water bottle assembly of claim 3, wherein said second reflective layer of said insulation unit is made from one of a copper film and an aluminum film.

5. The insulated water bottle assembly of claim 4, wherein said insulative layer of said insulation unit is fabricated from a sponge-like material.

6. The insulated water bottle assembly of claim 5, wherein said inner shell includes a container portion defining said liquid-holding space and that has a top end, and a lid removably threaded to said top end.

7. The insulated water bottle assembly of claim 6, wherein said lid of said inner shell includes a spigot that is operable to selectively communicate said liquid-holding space with the outside environment when said lid is threaded to said top end of said container portion.
